(19) United States
(12) Patent Application Publication
(10) Pub. No.: US 2005/0159168 A1
(43) Pub. Date: Jul. 21, 2005

(54) Network support for forwarding incoming fax call to mobile fax device

(75) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: Richard J. Minnich, Esq.;Fay, Sharpe,Fagan, Minnich & McKee, LLP, Seventh Floor, 1100 Superior Avenue, Cleveland, OH, 44114-2518, US

(73) Assignee: Lucent Technologies Inc.

(21) Appl. No.: 10/762,011

(22) Filed: Jan. 21, 2004

(51) Int. Cl. H04Q 7/20

(52) U.S. Cl. 455/455

(57) ABSTRACT

A method for a wireless network to forward an incoming call to a subscriber's primary mobile directory number on to a mobile fax directory number assigned to the subscriber includes: a) associating the mobile fax directory number with the primary mobile directory number, b) determining that the incoming call is a fax call, and c) forwarding the incoming call to the mobile fax directory number. In another embodiment, a method for a wireless network to forward an incoming call to a subscriber's mobile fax directory number is provided. In still another embodiment a wireless network for forwarding an incoming call to a mobile fax directory number assigned to a subscriber includes: means for associating the mobile fax directory number with the primary mobile directory number, means for determining that the incoming call is a fax call, and means for forwarding the incoming call to the mobile fax directory number.

### BACKGROUND OF INVENTION

The invention generally relates to wireless network support for forwarding an incoming fax call to a mobile fax device and will be described with particular reference thereto. However, it is to be appreciated that the invention is also amenable to other applications.

Today, more and more people use mobile stations (MSs) or similar mobile devices for personal communications. They may even cancel landline services and use the MS as their primary telephone number. Fax devices have also become more and more popular with consumers. Many people have added a fax device to their home and/or office. Mobile fax devices, such as the PM70 mobile fax by Possio, Taby (Stockholm), Sweden, are now available. Thus, people now may have both an MS and a mobile fax device with each having a unique directory number (DN). Under these circumstances, it is inconvenient for a person having both an MS and a mobile fax device to have to provide both DNs to others that may wish to contact them.

A wireless network currently knows that a particular call is a fax call based on the media type that is included in the signaling at the bearer level. This signaling indicates whether the media type is voice, fax, dtmf (digits), etc. As an example, a wireless network can be used as a transport network (network B in a “A calls C configuration,” where B is needed as a hop network in between A and C). If a call comes in destined for network C, network B (i.e., the wireless network) can recognize it as a fax call and make the appropriate modifications at the bearer level (e.g., with echo cancellation, etc.) and then pass the call to C. This type of configuration is based on business arrangements in place between the pertinent service providers. However, even though the wireless network can distinguish between voice and fax calls, it cannot currently forward an incoming fax call to a DN assigned to an MS on to an associated mobile fax device having a different DN.

As can be appreciated from the foregoing, wireless networks do not currently support forwarding an incoming fax call to a mobile fax device. If a wireless network could support such forwarding, the subscriber could simply provide one number (e.g., the DN assigned to the MS) to persons that may wish to contact them via either voice or fax. Thus, there is motivation to upgrade a wireless network to support forwarding an incoming fax call to a mobile faxing device.

### BRIEF SUMMARY OF INVENTION

In one aspect of the invention, a method for a wireless network to forward an incoming call to a subscriber's primary mobile directory number on to a mobile fax directory number assigned to the subscriber is provided. The method includes: a) associating the subscriber's mobile fax directory number with the subscriber's primary mobile directory number, b) determining that the incoming call is a fax call, and c) forwarding the incoming call to the subscriber's mobile fax directory number.

In another aspect of the invention, a method for a wireless network to forward an incoming call to a subscriber's mobile fax directory number is provided. The method includes: a) associating the subscriber's mobile fax directory number with a primary mobile directory number assigned to the subscriber, b) receiving the incoming call from a calling party to the subscriber's primary mobile directory, c) determining that the incoming call is a fax call, d) forwarding the incoming call to the subscriber's mobile fax directory number, e) determining if the incoming call forwarded to the subscriber's mobile fax directory number was connected, f) if the incoming call was connected, determining if the fax was completed, and g) if the fax was completed, communicating a success status message to the calling party, wherein the success status message includes the number of pages received.

In still another aspect of the invention, a wireless network for forwarding an incoming call to a subscriber's primary mobile directory number on to a mobile fax directory number assigned to the subscriber is provided. The wireless network includes: means for associating the subscriber's mobile fax directory number with the subscriber's primary mobile directory number, means for determining that the incoming call is a fax call, and means for forwarding the incoming call to the subscriber's mobile fax directory number.

Benefits and advantages of the invention will become apparent to those of ordinary skill in the art upon reading and understanding the description of the invention provided herein.

### BRIEF DESCRIPTION OF DRAWINGS

The invention is described in more detail in conjunction with a set of accompanying drawings.

FIG. 1 is a block diagram of an exemplary telecommunication network in which a wireless network forwards incoming fax calls for a primary mobile DN to a mobile fax device at an associated mobile fax DN.

FIG. 2 is a flowchart of an exemplary process for a wireless network to forward an incoming fax call for a primary mobile DN to a mobile fax device at an associated mobile fax DN.

FIG. 3 is a call flow diagram of an exemplary process for a wireless network to forward an incoming fax call for a primary mobile DN to a mobile fax device at an associated mobile fax DN.

### DETAILED DESCRIPTION

While the invention is described in conjunction with the accompanying drawings, the drawings are for purposes of illustrating exemplary embodiments of the invention and are not to be construed as limiting the invention to such embodiments. It is understood that the invention may take form in various components and arrangement of components and in various steps and arrangement of steps beyond those provided in the drawings and associated description. In the drawings, like reference numerals denote like elements and similar reference numerals denote similar elements.

In general, the invention provides a wireless network to support receiving faxes without the need for a landline phone line. Using a primary mobile DN associated with a subscriber, the wireless network permits the subscriber to associate a mobile fax device at a mobile fax DN with the primary mobile DN even though the mobile fax DN is assigned to the mobile fax device and the primary mobile DN is assigned to an MS or similar type of mobile device. Additionally, the invention permits use of the primary mobile DN by calling parties as a fax number, so that when the wireless network recognizes an incoming call as a fax, in one embodiment, it may automatically transfer or forward the data to the unique mobile fax DN that the subscriber has for receiving faxes. This saves the subscriber from having to give out multiple phone numbers—one for voice and one for faxing.

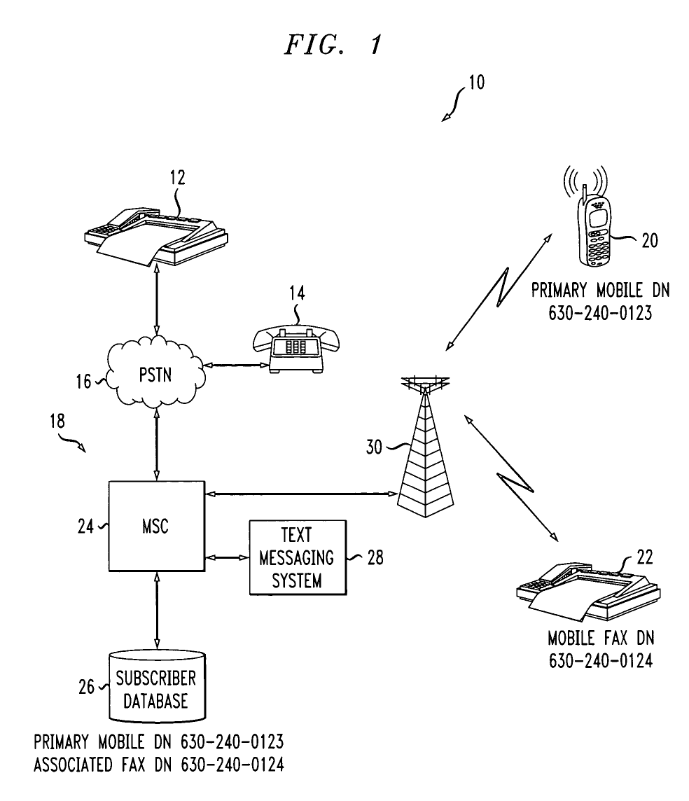

With reference to FIG. 1, an exemplary embodiment of a telecommunication network 10 includes a landline fax device 12, a landline telephone device 14, a public switched telephone network (PSTN) 16, a wireless network 18, an MS 20, and a mobile fax device 22. The wireless network 18 includes a mobile switching center (MSC) 24, a subscriber database 26, a text messaging system 28, and a base station (BS) 30. While the landline fax device 12, landline telephone device 14, and PSTN 16 are depicted, this portion of the telecommunication network 10 could be replaced by a second wireless network similar to the wireless network 18 shown. Alternatively, the landline fax device 12 could be replaced by a second mobile fax device serviced by the wireless network 18 and the landline telephone device 14 could be replaced by a second MS serviced by the wireless network 18. In this alternative, the PSTN 16 may not be required for the scenarios described below. The text messaging system 28 uses any suitable implementation of existing text message communication technology, such as SMS.

The wireless network 18 is associated with a wireless service provider that provides wireless service to subscribers. For example, a subscriber has procures a calling plan for wireless service to the MS 20 and mobile fax device 22 from the wireless service provider via the wireless network 18. The wireless service provider and wireless network 18 have associated a primary mobile DN with the MS 20 and a mobile fax DN with the mobile fax device 22. The subscriber sets up the calling plan with the wireless service provider to include a forwarding feature that identifies incoming fax calls to the primary mobile DN and forwards them to the mobile fax DN. The subscriber may also select a mode for the fax call forwarding feature. The subscriber database 26 maintains a record of the subscriber's calling plan for the MS 20 and mobile fax device 22 which associates the mobile fax DN with the primary mobile DN, particularly with respect to the forward incoming fax call feature. For example, calling plan records in the subscriber database are indexed or referenced by DN and include a fax call forwarding feature segment which may include an activation bit and a mode 2-bit parameter. The activation bit is either on or off depending on whether or not the subscriber has activated the feature. The mode parameter can specify up to four modes for the fax call forwarding feature and a default mode may be identified if the subscriber does not select a mode. Of course, other suitable arrangements of bits and parameters in the fax call forwarding feature segment are also envisioned, particularly if more than four modes are possible.

In one exemplary scenario, the telecommunication network 10 routes incoming voice calls from the landline telephone device 14 to the MS 20 (i.e., called party number is the primary mobile DN) via the PSTN 16 and wireless network 18 using, for example, existing messaging and switching technology. Similarly, in another exemplary scenario, the telecommunication network 10 routes incoming fax calls from the landline fax device 12 to the mobile fax device 22 (i.e., called party number is the mobile fax DN) via the PSTN 16 and wireless network 18 using, for example, existing messaging and switching technology. In still another exemplary scenario, the telecommunication network 18 also routes incoming fax calls from the landline fax device 12 to the mobile fax device 22 when the called party number is the primary mobile DN if the subscriber has set up the forwarding feature that identifies incoming fax calls to the primary mobile DN and forwards them to the mobile fax DN associated with the primary mobile DN in his or her calling plan. It is understood that the call path through the wireless network 18 in each scenario is via the MSC 24 and BS 30.

In this forwarding incoming fax call scenario, in one embodiment, the wireless network 18 recognizes the incoming call to the subscriber's primary mobile DN as a fax and automatically transfers or forwards the incoming fax call to the mobile fax DN associated with the primary mobile DN. In another embodiment, the forwarding operation may be delayed until the subscriber or another user activates a control or sequence of controls on the MS. The control(s) may be associated with a standard MS keypad, other standard MS controls, or a dedicated control on the MS. For example, the wireless network may connect the incoming call to the subscriber's primary mobile directory number and wait for a control message via the subscriber's primary mobile directory number instructing the wireless network to forward the incoming call to the subscriber's mobile fax directory number. Upon receiving the control message, the wireless network begins the forwarding operation. In still another embodiment, the wireless network 18 recognizes the incoming call to the subscriber's primary mobile DN as a fax, continues processing the call to the subscriber's primary mobile DN, and upon the subscriber answering the call at the MS 20, the wireless network 18 transfers or forwards the incoming fax call to the mobile fax DN associated with the primary mobile DN. In each of these embodiments, people sending the subscriber a fax then only have to remember one telephone number for the subscriber for both voice and fax calls. In other words, they would not have to remember one mobile number for voice calls and a different number for fax calls. All three embodiments may be implemented together in different modes of the fax call forwarding feature with the mode parameter in the fax call forwarding feature segment of the subscriber's calling plan record identifying the mode that is currently selected. For example, the automatic forwarding embodiment may be a default mode and identified by a first value for the mode parameter, the forward on activation of MS control embodiment may be a second mode and identified by a second value for the mode parameter, and the forward on MS answer embodiment may be a third mode and identified by a third value for the mode parameter.

After the incoming fax call to the primary mobile DN is connected to the mobile fax device 22 and the fax is successfully completed, the MSC 24 communicates a success status message to the calling party as an acknowledgement message. The acknowledgement message may include the number of pages received. The MSC 24 also sends a text message to the primary mobile DN to report a fax was received to the subscriber. The text message may include the number of pages received. The text message is initially communicated to the text messaging system 28. The text messaging system stores and delivers the text message using, for example, existing messaging and switching technology (i.e., SMS technology). Likewise, the MS 20 provides a cue and means for retrieval of the text message using, for example, existing SMS technology. If the incoming fax call is not connected to the mobile fax device 22 or the incoming fax is not completed, the MSC 24 communicates a fail status message to the calling party as an acknowledgement message.

In summary, the wireless network 18 provides a methodology for receiving faxes at a mobile fax device. Additionally, the wireless network 18 provides a methodology for the network to recognize a primary mobile DN as being associated with a mobile fax device. Moreover, the wireless network 18 provides a methodology for the network to recognize an incoming fax call to the subscriber's primary mobile DN as a fax and, upon pressing a control at the MS, automatically transferring or forwarding the incoming call to the mobile fax DN associated with the primary mobile DN and a mobile fax device. Furthermore, the wireless network 18 provides a methodology for the network to recognize an incoming fax call to a subscriber's primary mobile DN as a fax and automatically transfer or forward the incoming call to the mobile fax DN associated with the primary mobile DN and a mobile fax device.

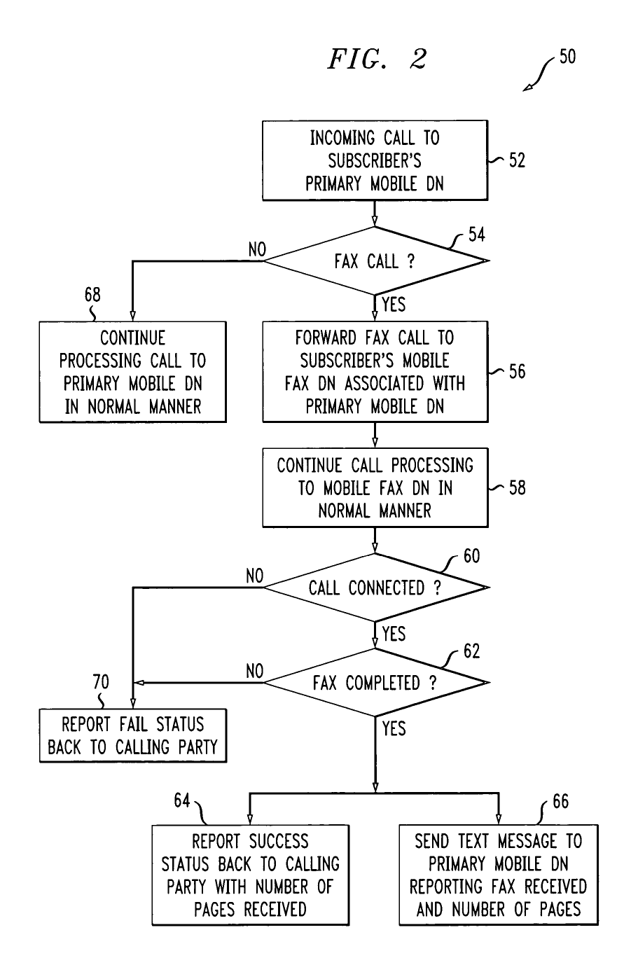

With reference to FIG. 2, an exemplary process 50 for a wireless network to forward an incoming fax call for a primary mobile DN to a mobile fax device at an associated mobile fax DN begins at step 52 where the wireless network receives an incoming call to a subscriber's primary mobile DN. At step 54, the wireless network determines whether the incoming call is a fax call. Next, if the incoming call is a fax call, the wireless network forwards the incoming fax call to the subscriber's mobile fax DN associated with the primary mobile DN (step 56). The mobile fax DN is associated with the primary mobile DN, for example, in the subscriber's calling plan identifying the nature and scope of wireless services procured by the subscriber from a wireless service provider associated with the wireless network. The subscriber's calling plan is stored and maintained, for example, in a subscriber database within the wireless network.

At step 58, the wireless network continues processing the incoming fax call to the mobile fax DN in a normal manner. Next, the wireless network determines if the incoming fax call was connected (step 60). If the incoming fax call was connected, at step 62, the wireless network determines if the fax was completed by, for example, evaluating an acknowledgement message from the mobile fax device after the connected call was terminated. Next, if the fax was completed, the wireless network communicates a success status message back to the calling party (step 64) and sends a text message to the primary mobile DN to notify the subscriber, via the MS, that a fax was received (step 66). One or both of the success status message and the text message may also include the number of pages received by the mobile fax device.

If the incoming call is not a fax call at step 54, the wireless network continues processing the incoming call to the primary mobile DN in a normal manner (step 68).

If the incoming fax call is not connected in step 60 or if the fax is not completed in step 62, the wireless network communicates a fail status message to the calling party (step 70).

The various steps in the foregoing process 50 may be implemented by hardware, software, and/or combinations thereof within the wireless network 18 (FIG. 1), including one or more of the MSC 24 (FIG. 1), subscriber database 26 (FIG. 1), and text messaging system 24 (FIG. 1). More specifically, steps 52, 54, 56, 58, 60, 62, 64, 66, 68, and 70 may be implemented at least in part by hardware, software, and/or combinations thereof within the MSC 24 (FIG. 1). Steps 56, 58, 66, and 68 may be implemented at least in part by hardware, software, and/or combinations thereof within the subscriber database 26 (FIG. 1). Step 66 may be implemented at least in part by hardware, software, and/or combinations thereof within the text messaging system 28 (FIG. 1).

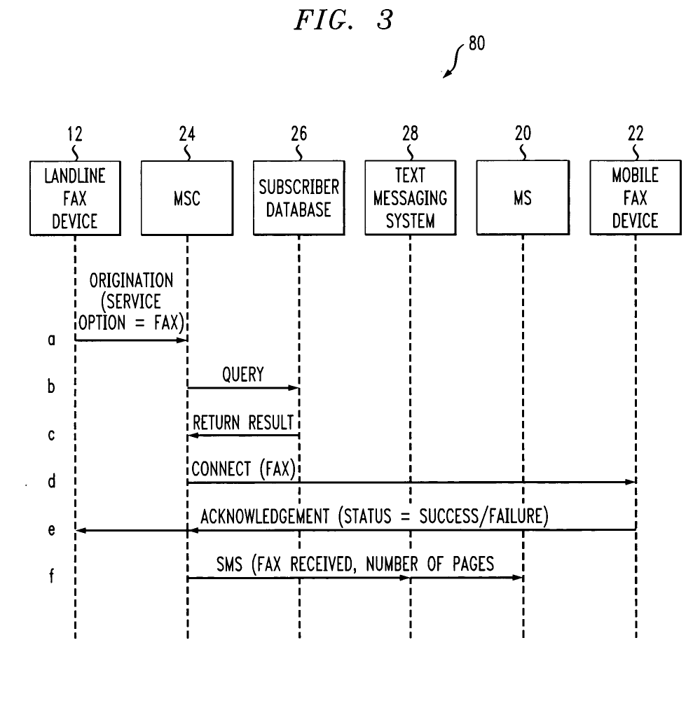

With reference to FIG. 3, an exemplary call flow diagram provides another view of the scenario described above in conjunction with FIG. 2 where the wireless network forwards an incoming fax call to a mobile fax device. The call flow begins at line a, where a landline fax device 12 originates a call with a fax service option to a primary mobile DN assigned to the MS 20. At line b, the MSC 24 queries the subscriber database 26 to determine if a subscriber associated with the MS 20 has activated a fax call forwarding feature in his or her calling plan and, if so, to determine if the subscriber has associated a mobile fax DN with the primary mobile DN. In response, the subscriber database 26, for example, sends a return result message to the MSC 24 that indicates that the fax call forwarding feature is activated and provides a mobile fax DN that is associated with the primary mobile DN in the subscriber's calling plan (line c).

At line d, the MSC 24 routes the incoming fax call to the mobile fax DN and connects the call to the mobile fax device 22 when it answers the call. Next, after the fax call is terminated, the mobile fax device 22 sends an acknowledgement message to the MSC 24 indicating whether the fax failed or was successful (line e). The MSC 24 relays the acknowledgement message to the calling party at the landline fax device 12 (line e). The acknowledgement message may include the number of pages received by the mobile fax device 22. At line f, if the acknowledgement message indicates that the fax was successful, the MSC 24 sends a text message using, for example, existing SMS technology to the text messaging system 28. The content of the text message is to notify the subscriber, via the MS 20, that a fax was received by the mobile fax device 22. The text messaging system 28 delivers the text message to the MS 20. The subscriber may retrieve the text message with the MS 20 using, for example, existing SMS technology.

While the invention is described herein in conjunction with exemplary embodiments, it is evident that many alternatives, modifications, and variations will be apparent to those skilled in the art. Accordingly, the embodiments of the invention in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof.

1. A method for a wireless network to forward an incoming call to a subscriber's primary mobile directory number on to a mobile fax directory number assigned to the subscriber, the method including the steps:
a) associating the subscriber's mobile fax directory number with the subscriber's primary mobile directory number;
b) determining that the incoming call is a fax call; and
c) forwarding the incoming call to the subscriber's mobile fax directory number.

2. The method set forth in claim 1, before step b), further including the step:
d) receiving the incoming call from a calling party to the subscriber's primary mobile directory.

3. The method set forth in claim 1, further including the step:
d) determining if the incoming call forwarded to the subscriber's mobile fax directory number was connected;
e) if the incoming call was connected, determining if the fax was completed; and
f) if the fax was completed, communicating a success status message to the calling party.

4. The method set forth in claim 3, further including the step:
g) if the incoming call was not connected, communicating a fail status message to the calling party.

5. The method set forth in claim 3, further including the step:
g) if the fax was not completed, communicating a fail status message to the calling party.

6. The method set forth in claim 3 wherein the success status message includes a number of pages received.

7. The method set forth in claim 3, further including the step:
g) if the fax was completed, communicating a text message to the subscriber's primary mobile directory number via a text messaging system, wherein the text message indicates that a fax was received at the subscriber's mobile fax directory number.

8. The method set forth in claim 7 wherein the text message includes a number of pages received.

9. The method set forth in claim 1, before step c), further including the step:
d) connecting the incoming call to the subscriber's primary mobile directory number;
e) waiting for a control message via the subscriber's primary mobile directory number instructing the wireless network to forward the incoming call to the subscriber's mobile fax directory number; and
f) receiving the control message via the subscriber's primary mobile directory number instructing the wireless network to forward the incoming call to the subscriber's mobile fax directory number.

10. The method set forth in claim 9 wherein the control message is automatically initiated when the incoming call is connected to the subscriber's primary mobile directory number.

11. The method set forth in claim 9 wherein the control message is initiated by activation of at least one control on a mobile device associated with the subscriber's primary mobile directory number.

12. A method for a wireless network to forward an incoming call to a subscriber's mobile fax directory number, the method including the steps:
a) associating the subscriber's mobile fax directory number with a primary mobile directory number assigned to the subscriber;
b) receiving the incoming call from a calling party to the subscriber's primary mobile directory;
c) determining that the incoming call is a fax call;
d) forwarding the incoming call to the subscriber's mobile fax directory number;
e) determining if the incoming call forwarded to the subscriber's mobile fax directory number was connected;
f) if the incoming call was connected, determining if the fax was completed; and
g) if the fax was completed, communicating a success status message to the calling party, wherein the success status message includes the number of pages received.

13. The method set forth in claim 12, further including the step:
h) if the incoming call was not connected, communicating a fail status message to the calling party.

14. The method set forth in claim 12, further including the step:
h) if the fax was not completed, communicating a fail status message to the calling party.

15. The method set forth in claim 12, further including the step:
h) if the fax was completed, communicating a text message to the subscriber's primary mobile directory number via a text messaging system, wherein the text message indicates that a fax was received at the subscriber's mobile fax directory number and includes the number of pages received.

16. A wireless network for forwarding an incoming call to a subscriber's primary mobile directory number on to a mobile fax directory number assigned to the subscriber, the wireless network including:
means for associating the subscriber's mobile fax directory number with the subscriber's primary mobile directory number;
means for determining that the incoming call is a fax call; and
means for forwarding the incoming call to the subscriber's mobile fax directory number.

17. The wireless network set forth in claim 16, further including:
means for receiving the incoming call from a calling party to the subscriber's primary mobile directory.

18. The wireless network as set forth in claim 16, further including:
means for determining if the incoming call forwarded to the subscriber's mobile fax directory number was connected;
means for determining if the fax was completed; and
means for communicating a success status message to the calling party, wherein the success status message includes a number of pages received.

19. The wireless network set forth in claim 16, further including:
means for communicating a text message to the subscriber's primary mobile directory number via a text messaging system, wherein the text message indicates that a fax was received at the subscriber's mobile fax directory number and the text message includes a number of pages received.

20. The wireless network set forth in claim 16, further including:
means for connecting the incoming call to the subscriber's primary mobile directory number;
means for waiting for a control message via the subscriber's primary mobile directory number instructing the wireless network to forward the incoming call to the subscriber's mobile fax directory number; and
means for receiving the control message via the subscriber's primary mobile directory number instructing the wireless network to forward the incoming call to the subscriber's mobile fax directory number.
